(19) United States
(12) Patent Application Publication
(10) Pub. No.: US 2024/0405605 A1
(43) Pub. Date: Dec. 5, 2024

(54) ENERGY HARVESTING MODULE AND LOW POWER RECTIFIER CIRCUIT

(71) Applicant: Ramot at Tel-Aviv University Ltd., Tel Aviv (IL)

(72) Inventors: Edoh SHAULOV, Tel Aviv (IL); Tal ELAZAR, Tel Aviv (IL); Eran SOCHER, Raanana (IL)

(21) Appl. No.: 18/697,206

(22) PCT Filed: Oct. 26, 2022
(86) PCT No.: PCT/IB2022/060287

§ 371 Date: Mar. 29, 2024

(30) Foreign Application Priority Data
Oct. 29, 2021 (GB) 2115556.9

(51) Int. Cl. H02J 50/00; H02J 50/10; H02M 7/217

(52) U.S. Cl. CPC H02J 50/001; H02J 50/10; H02M 7/217

(57) ABSTRACT

Disclosed herein is an energy harvesting module, including an antenna having a planar radiator and configured to receive incoming electromagnetic radiation and generate an AC antenna signal; a rectifier circuit arranged in a plane parallel to and adjacent to the planar radiator and configured to rectify the AC antenna signal and generate a DC battery charging signal; and a battery configured to receive the DC battery charging signal.

This application is a National Phase entry of International Application No. PCT/IB2022/060287 under § 371 and claims the benefit of GB Patent Application No. 2115556.9, filed Oct. 29, 2021, which is hereby incorporated by reference in its entirety.

### FIELD OF THE DISCLOSURE

This disclosure relates in general to the field of energy harvesting and, in particular, to harvesting radio frequency (RF) energy in a module with a rectifier circuit.

### BACKGROUND

An energy harvesting module has far-reaching commercial uses. Such a module, or an array of them, can be coupled to any wireless device, from cellphones to sensors, to pacemakers etc., enabling this wireless device to be charged wirelessly, either actively or even passively. One of the fundamental and fast-emerging markets that such a harvesting module can further enable is the Internet of Things (IoT) market, which is based on the communication of wireless sensor networks, which cannot be sustained using classical battery-charging techniques.

Existing devices for energy harvesting are typically very inefficient, primarily due to the low rectification efficiency they offer. Such devices are limited in their target frequencies of operation, typically in the range of 900 MHZ to 2.4 GHZ, and are further limited by their form factor, generally relying on a conventional printed circuit board (PCD) with an antenna and discrete rectifier components laid on top.

Embodiments of the invention aim to solve the following problems: (i) limited battery life in wireless electronics, (ii) low rectification efficiency for far-field rectennas used for wireless power transmission, (iii) scalability limitations for rectenna arrays limiting available power delivered wirelessly.

### SUMMARY

According to a first aspect of the present disclosure, there is provided an energy harvesting module according to the present claims.

According to a second aspect of the present disclosure, there is provided a rectifier circuit according to the present claims.

According to a third aspect of the present disclosure, there is provided an energy harvesting array according to the present claims.

### BRIEF DESCRIPTION OF THE DRAWINGS

For a better understanding of embodiments of the present invention and to show more clearly how it may be carried into effect, reference will now be made by way of example only, to the accompanying drawings, in which:

FIG. 1 is schematic of an energy harvesting module according to an embodiment;

FIG. 2 is a lateral view of an energy harvesting module according to an embodiment;

FIG. 3 is a schematic diagram showing a stacked arrangement of rectifier circuits according to an embodiment;

FIG. 4 is a schematic diagram showing a rectifier circuit according to an embodiment;

FIG. 5 is a chart showing simulated transient drain current and transistor node voltages;

FIG. 6 is a chart showing simulated output spectrum and transient output voltage according to an embodiment; and

FIG. 7 is a schematic diagram showing an energy harvesting array according to an embodiment.

### DETAILED DESCRIPTION

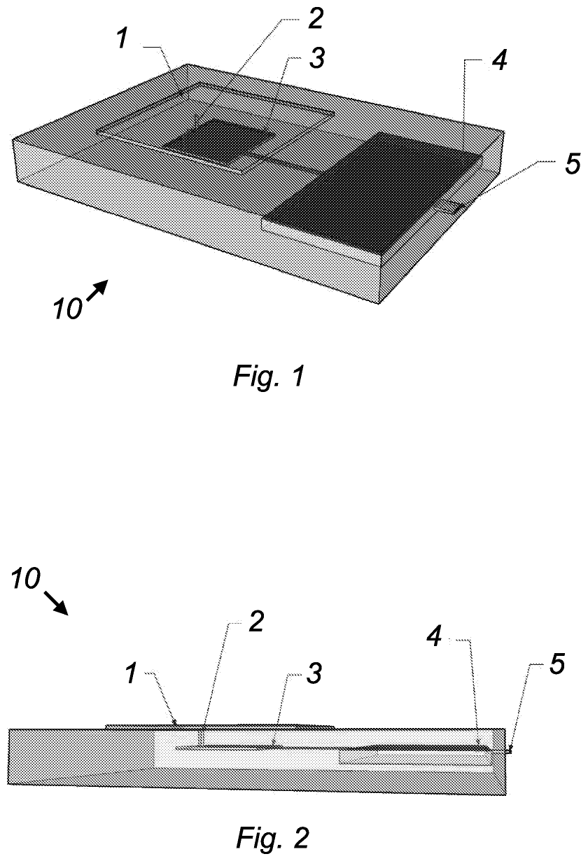

FIG. 1 of the accompanying drawings shows an energy harvesting module 10 according to an embodiment. The energy harvesting module 10 comprises an antenna 1, a rectifier circuit 3 and a battery 4.

The antenna 1 has a planar radiator and is configured to receive incoming electromagnetic (EM) radiation and generate an alternating current (AC) antenna signal. The rectifier circuit 3 is arranged in a plane parallel to and adjacent to the planar radiator and configured to rectify the AC antenna signal and generate a direct current (DC) battery charging signal. The battery 4 is configured to receive the DC battery charging signal. The planar radiator of the antenna 1 may be arranged to overlap or overlay the rectifier circuit 3 in parallel planes, to form a stacked arrangement as illustrated in FIG. 1 and FIG. 2.

In this way, an antenna 1 to rectifier 3 distance can be minimized. That is, the length of an interconnect 2 between the antenna 1 and rectifier circuit 3 can be minimized. By stacking these components no high frequency lines are exposed and thus RF interconnection losses are reduced.

FIG. 2 shows a lateral view of the energy harvesting module 1. As shown, the interconnect 2 between the antenna 1 and rectifier 3 is very short. These interconnects 2 carry the RF current from the antenna 1 to the rectifier 3 and would normally be subject to high losses, typically from 30% to 50%. However, by embedding the rectifier 3 within the package, and below the antenna 1, these interconnects 2 can now transfer the current from the antenna 1 to the rectifier 3 in a minimalistic fashion; without the use of BGAs, wire-bonding or soldering and with a minimal loss of only 10%.

In this way, the energy harvesting module 10 has reduced losses and is much more efficient. This can solve a problem of limited battery life in wireless electronics. By solving the problem of low efficiency the module can allow any device to be charged wirelessly using a dedicated source or ambient energy. Furthermore, the reduced form factor provides improved modularity, allowing multiple modules to be used in a smaller space.

The antenna 1, the rectifier circuit 3 and the battery 4 may be enclosed in a casing. Thus the rectifier circuit 3 and antenna 1 may be encapsulated in a single homogenous package. The antenna 1 may be embedded on the top most layer of the casing. The arrangement of components in the package may therefore provide an Antenna-in-Package (AiP) device. The casing may be a metallic or dielectric material, as required. The casing may be homogenous. In some examples, the rectifier circuit 3 may be embedded within a cavity of the casing. By encasing the antenna and rectifier in this way, the losses between the antenna and rectifier can be improved by 50-80% in comparison with a standard PCB.

The energy harvesting module 10 may further comprises a DC output 5 connected to the battery 4. In this way, modularity of the module is improved, allowing multiple modules to be stacked or arranged in a small space. This further enables the encapsulation of all RF traces within the package. This is advantageous as it increases the modularity and, therefore, scalability of the energy harvesting module.

Alternatively, in some embodiments, the battery 4 and/or DC output 5 may be arranged outside the enclosure. For example, the battery 4 may be connected to an external surface of the enclosure.

The antenna 1 is configured to transduce EM radiation to electrical voltage and current. The antenna 1 may be, for example, a patch antenna, loop antenna, end fire antenna or any other suitable type. The antenna 1 may have a radiating direction which is normal or transverse to the plane, or any other direction. The energy harvesting module 10 may include multiple antennae of the same or different types.

The antenna 1 may be configured to generate the AC antenna signal from electromagnetic radiation having a frequency greater than 24 GHz. For example, the antenna 1 may be configured to generate the AC antenna signal from electromagnetic radiation in the 5G NR FR2 band (i.e. fifth generation wireless new radio interface frequency band two) between 26.5 GHZ and 29.5 GHZ. Energy harvesting in the frequency band between 26.5 GHZ and 29.5 GHz allows for the use of small or compact antennas, is non-ionizing and benefits from low atmospheric attenuation relative to neighboring frequencies. Such antennas operate using far-field EM radiation. In this way the module 10 can be adapted to harvest energy from high-power mobile signals.

The rectifier circuit 3 may be an integrated circuit, e.g. as described in more detail below. By implementing the rectifier as an integrated circuit, the module can be implemented without any strip line components, lumped components or solder-mount components, thereby improving the efficiency of the module. The rectifier circuit 3 may be arranged on a different level to the antenna 1, rather than on the same plane, reducing the minimum possible distance between the two components.

The rectifier circuit 3 may include an analog battery charging unit configured to control the DC battery charging signal. The analog battery charging unit may stabilize or even out the signal e.g. based on feedback from the battery 4.

The antenna 1 and the rectifier circuit 3 may be arranged in a stack with at least one dielectric layer between. In some examples, there may be more rectifier circuits with a dielectric layer between each additional layer.

The energy harvesting module 10 may further include one or more additional rectifier circuits.

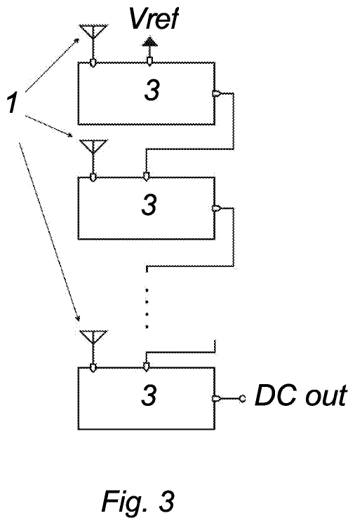

FIG. 3 is a schematic diagram showing a stacked arrangement of rectifier circuits according to an embodiment. An output node of each additional rectifier may be connected to a reference voltage of the preceding rectifier. In this way, the module can provide higher output voltages. This implementation doesn't require a change to the rectifier circuit itself, making it very modular.

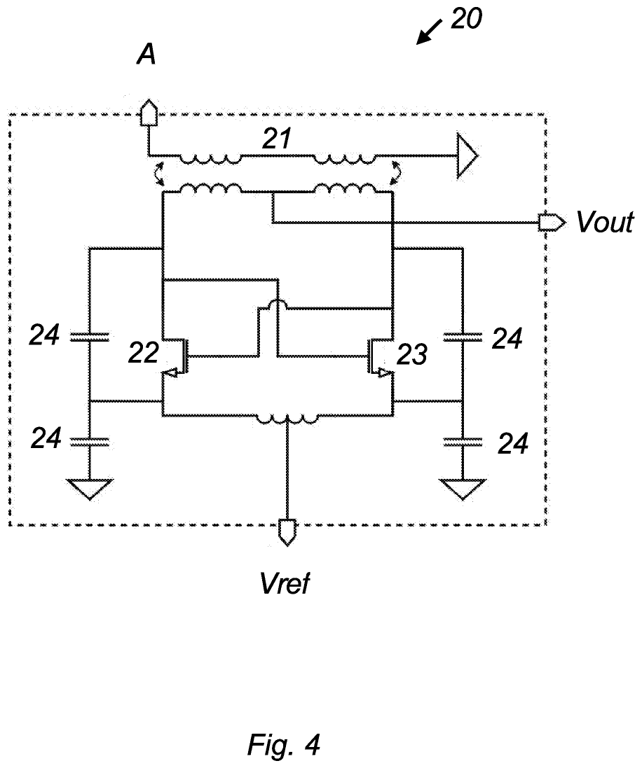

FIG. 4 of the accompanying drawings shows a rectifier circuit 20 according to an embodiment. The rectifier circuit 20 comprises an input feed A, a power matching unit 21, a first transistor 22 and a second transistor 23, a plurality of feedback capacitors 24 and an output node Vout.

The input feed A is configured to receive an oscillating signal. The power matching unit 21 is configured to power match the oscillating signal. The first transistor 22 and second transistor 23 are each connected between the input feed A and a reference voltage Vref. A first input signal at a drain of the first transistor 22 has an opposite phase to a second input signal at a drain of the second transistor 23. A gate of the first transistor 22 is connected to the drain of the second transistor 23 and a gate of the second transistor 23 is connected to the drain of the first transistor 22.

To achieve a positive output voltage, the DC drain current should be negative. The topology aims to maximize the negative current while limiting the positive current, allowing high efficiency rectifying. As gate and drain are in opposite phase, this circuit can maximize negative current, and limit positive current, providing a positive output voltage.

The transistor modes of operation can be divided into three regions:

In the region where the VGS>VTH, VDS is negative, resulting in a maximum negative current.

While VGS is decreasing and VDS is rising and the transistor is still conducting, the current flips polarity and turns positive.

In the region where VGS<VTH, the transistor is in subthreshold and the negative VDS turns the current negative again.

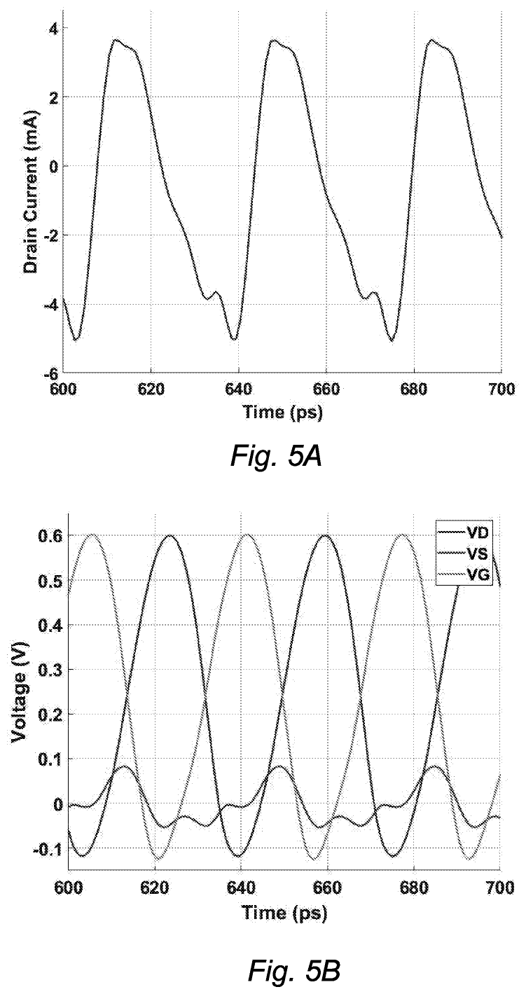

FIG. 5 is a chart showing simulated transient drain current and transistor node voltages.

The feedback capacitors each connect a source of one of the first and second transistors with the respective drain. The circuit 20 may include two feedback capacitors 24 for each of the first transistor 22 and second transistor 23 That is, the two capacitors 24 sample the drain voltage and feed it back to the source. In this way, a voltage of the source is at a maximum value when the respective input signal at the drain voltage is at a peak. In this way, the positive current can be further limited.

The output node Vout is connected to the drain of the first transistor 22 and the drain of the second transistor 23. The output node Vout is configured to generate a DC output signal based on a sum of the currents passing through both of the transistors. In this way, the rectifier circuit 21 can achieve high efficiencies at low power, based on a high-frequency (e.g. radio frequency) input. In addition, summing the currents at the common node can generate a ripple in the second harmonic, making it easier to filter.

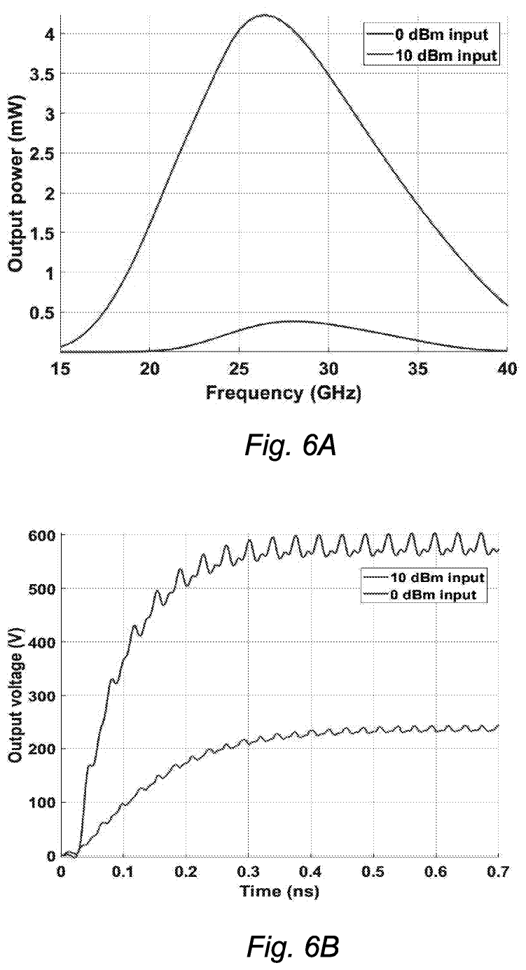

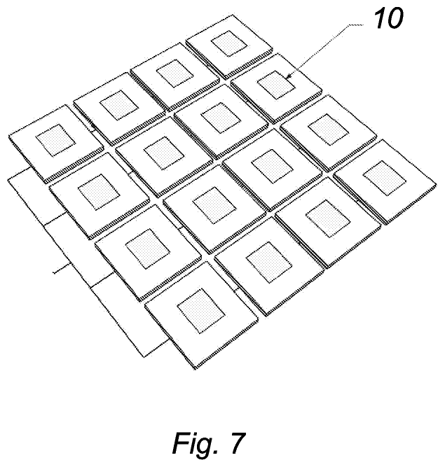

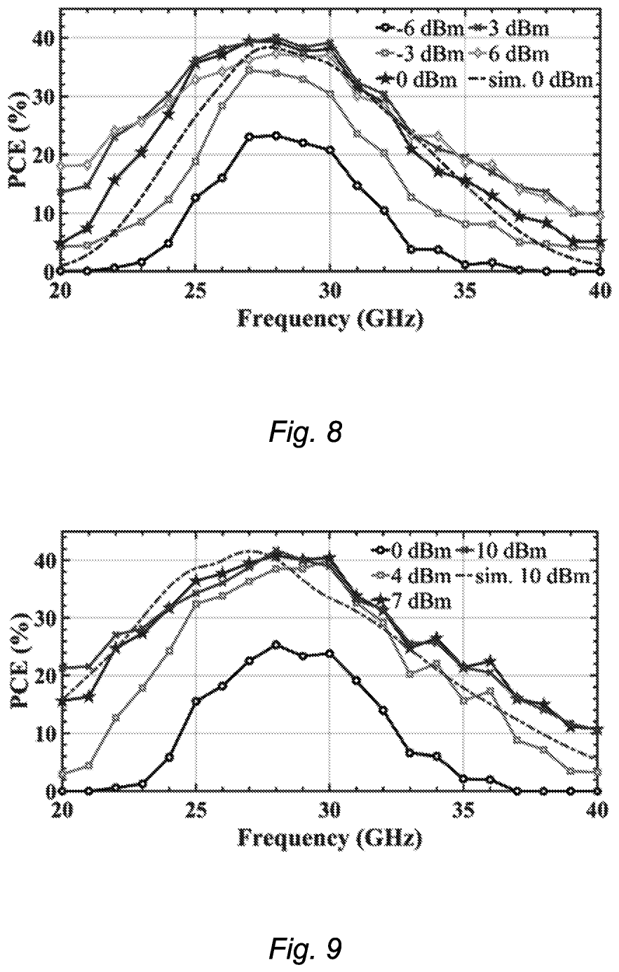

FIG. 6 is a chart showing simulated output spectrum and transient output voltage according to an embodiment.

Whereas efficiencies of low power RF rectifiers are normally below 20%, it is possible to achieve 30-40%, efficiency values which are normally achieved only at higher power levels. The rectifier can achieve 38% to 40% RF to DC conversion efficiency, or power conversion efficiency (PCE), at 0 dBm with low VTH devices and 41% to 42% RF to DC conversion efficiency, or PCE, at 10 dBm with high VTH devices.

The power matching unit 21 may include a transformer configured to receive the oscillating signal and generate the first input signal and second input signal. The output node Vout may connected to a midpoint of the transformer. This provides the required power matching in a compact way, couples the rectifier circuit energy with the input, and provides a compact and effect way of implementing the output node.

Each of the transistor devices 22, 23 may be configured with a preset threshold voltage based on an expected power value of the oscillating signal. In this way, the rectifier can be configured to operate at maximum efficiency for different input power values e.g. for harvesting or active charging applications. For example, the transistors can be low VTH devices targeting maximum efficiency at ˜ 0 dBm, or high VTH devices targeting maximum efficiency at ˜ 10 dBm.

The rectifying circuit 20 may be fabricated in TSMC 65 nm. FIG. 8 illustrates PCE for a low VTH device fabricated in TSMC 65 nm and FIG. 9 illustrates PCE for a high VTH device fabricated in TSMC 65 nm, where the rectified output is measured on a potentiometer using an ammeter and voltmeter, simultaneously. In order to de-embed the voltage drop on the ammeter, it is included as the load. PCE is characterized according to PCE=POUT_DC/PIN_RF, where POUT_DC is the rectified DC power and PIN_RF is the RF power delivered to the energy harvesting module 10.

In FIG. 8, the low VTH device PCE is characterized with respect to frequency and to input power. In FIG. 8 PCE with low VTH transistors is illustrated, for a variety of input powers with respect to frequency. A PCE of 40% with a 3 dB bandwidth (BW) from 23 GHz to 33 GHz is achieved for powers between 0 dBm and 3 dBm.

In FIG. 9, the high VTH device PCE is characterized with respect to frequency and to input power. In FIG. 9 PCE with high VTH transistors is illustrated, for a variety of input powers with respect to frequency. A PCE of above 42% is achieved with a 3 dB BW from 21 GHz to 35 GHz for power >7 dBm.

The PCE with respect to input power at an optimal frequency of 28 GHz for the low VTH device and the high VTH device are compared and presented in FIG. 10. The low VTH device performs better at lower input powers and the high VTH device is better suited for higher input powers, while both devices attain at least 40% PCE at their respective peaks.

The energy harvesting module 10 described with respect to FIG. 1 may include the rectifier circuit 20 described above. In this way, the efficiency provided by the rectifier circuit can allow the module to operate in a smaller form factor, based on lower available energies. This can expand the potential use cases of a modular device based on the energy harvesting module.

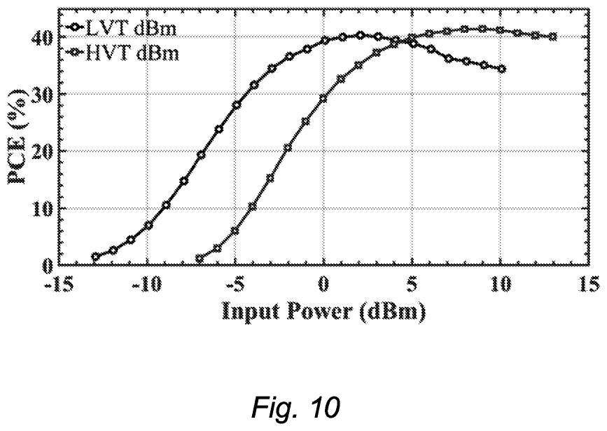

FIG. 7 of the accompanying drawings shows an energy harvesting array according to an embodiment. The array includes a plurality of energy harvesting modules. This implementation is made possible by the significantly reduced form factor of the energy harvesting module and allows a significant number of modules to be combined such that a usable energy harvesting output can be achieved. Furthermore, the harvesting modules are interconnected by DC lines alone—that is, there are no RF connections outside the package. The absence of RF lines and the modular design allows for easy and low cost scalability. The absence of RF connections outside the package broadens the number of viable substrate materials for the array, and allows the substrate to be of any material without hindering performance: flexible, porous, and non-dielectric.

Although aspects of the invention herein have been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the scope of the invention as defined by the appended claims.

1. An energy harvesting module, comprising:
an antenna having a planar radiator and configured to receive incoming electromagnetic radiation and generate an AC antenna signal;
a rectifier circuit arranged in a plane parallel to, and adjacent to, the planar radiator and configured to rectify the AC antenna signal and generate a DC battery charging signal; and
a battery configured to receive the DC battery charging signal.

2. The energy harvesting module of claim 1, wherein the antenna and the rectifier circuit are arranged in a stack with at least one dielectric layer between.

3. The energy harvesting module of claim 1, wherein the antenna, the rectifier circuit, and the battery are enclosed in a casing, and wherein the energy harvesting module further comprises a DC output connected to the battery.

4. The energy harvesting module of claim 1, further comprising one or more additional rectifier circuits, wherein an output node of each of the one or more additional rectifier circuits is connected to a reference voltage of a preceding rectifier circuit.

5. The energy harvesting module of claim 1, wherein the rectifier circuit comprises an analog battery charging unit configured to control the DC battery charging signal.

6. The energy harvesting module of claim 1, wherein the antenna is configured to generate the AC antenna signal from electromagnetic radiation having a frequency greater than 24 GHz.

7. A rectifier circuit comprising:
an input feed configured to receive an oscillating signal;
a power matching unit configured to power match the oscillating signal;
a first transistor and a second transistor, each connected between the input feed and a reference voltage, wherein a first input signal at a drain of the first transistor has an opposite phase to a second input signal at a drain of the second transistor, and wherein a gate of the first transistor is connected to the drain of the second transistor and a gate of the second transistor is connected to the drain of the first transistor;
two feedback capacitors, each connecting a source of one of the first and second transistors with its respective drain, such that a voltage of the source is at a maximum value when a respective input signal at a drain voltage is at a peak; and
an output node connected to the drain of the first transistor and the drain of the second transistor and configured to generate the DC output signal based on a sum of the currents passing through both the first transistor and the second transistor.

8. The rectifier circuit of claim 7, wherein the power matching unit comprises a transformer configured to receive the oscillating signal and generate the first input signal and second input signal, wherein the output node is connected to a midpoint of the transformer.

9. The rectifier circuit of claim 7, wherein each of the first transistor and the second transistor is configured with a preset threshold voltage based on an expected power value of the oscillating signal.

10. The energy harvesting module of claim 1, further comprising a rectifier circuit, wherein the rectifier circuit comprises:
an input feed configured to receive an oscillating signal;
a power matching unit configured to power match the oscillating signal;
a first transistor and a second transistor, each connected between the input feed and a reference voltage, wherein a first input signal at a drain of the first transistor has an opposite phase to a second input signal at a drain of the second transistor, and wherein a gate of the first transistor is connected to the drain of the second transistor and a gate of the second transistor is connected to the drain of the first transistor;
two feedback capacitors, each connecting a source of one of the first and second transistors with its respective drain, such that a voltage of the source is at a maximum value when a respective input signal at a drain voltage is at a peak; and
an output node connected to the drain of the first transistor and the drain of the second transistor and configured to generate the DC output signal based on a sum of currents passing through both the first transistor and the second transistor.

11. An energy harvesting array comprising:
a plurality of energy harvesting modules, wherein the plurality of energy harvesting modules comprises the energy harvesting module of claim 1, and
wherein the plurality of energy harvesting modules further comprises a rectifier circuit, wherein the rectifier circuit comprises:
an input feed configured to receive an oscillating signal;
a power matching unit configured to power match the oscillating signal;
a first transistor and a second transistor, each connected between the input feed and a reference voltage, wherein a first input signal at a drain of the first transistor has an opposite phase to a second input signal at a drain of the second transistor, and wherein a gate of the first transistor is connected to the drain of the second transistor and a gate of the second transistor is connected to the drain of the first transistor;
two feedback capacitors, each connecting a source of one of the first and second transistors with its respective drain, such that a voltage of the source is at a maximum value when a respective input signal at a drain voltage is at a peak; and
an output node connected to the drain of the first transistor and the drain of the second transistor and configured to generate the DC output signal based on a sum of currents passing through both the first transistor and the second transistor.
